(19) United States
(12) Patent Application Publication
(10) Pub. No.: US 2020/0036218 A1
(43) Pub. Date: Jan. 30, 2020

(54) Wireless Power Transfer Circuitry with a Multi-Path Architecture

(71) Applicant: Qualcomm Incorporated, San Diego, CA (US)

(72) Inventors: Joseph Maalouf, San Diego, CA (US); Sumukh Ashok Shevde, Encinitas, CA (US); Didier Farenc, San Diego, CA (US); Cheong Kun, San Diego, CA (US); Georgios Konstantinos Paparrizos, Foster City, CA (US)

(21) Appl. No.: 16/358,312

(22) Filed: Mar. 19, 2019

Related U.S. Application Data
(60) Provisional application No. 62/791,592, filed on Jan. 11, 2019.
(60) Provisional application No. 62/703,330, filed on Jul. 25, 2018.

(51) Int. Cl. H02J 7/02; H01F 38/14; H02J 50/10

(52) U.S. Cl. CPC H02J 7/027; H02J 7/025; H02M 3/07; H02J 50/10; H01F 38/14

(57) ABSTRACT

An apparatus is disclosed for wireless power transfer circuitry with a multi-path architecture. In an example aspect, the apparatus includes a wireless power receiver with at least one receiving element, at least one output power node, and two or more power paths having at least one power path configured to be selectively activated. The two or more power paths are coupled between the at least one receiving element and the at least one output power node.

### CROSS-REFERENCE TO RELATED APPLICATION(S)

This application claims the benefit of U.S. Provisional Application No. 62/703,330, filed 25 Jul. 2018, and U.S. Provisional Application No. 62/791,592, filed 11 Jan. 2019; the disclosures of which are hereby incorporated by reference in their entirety herein.

### TECHNICAL FIELD

This disclosure relates generally to wireless power delivery or wireless charging and, more specifically, to wireless power transfer circuitry having a multi-path architecture for thermal management.

### BACKGROUND

Wireless power transfer systems provide a convenient alternative to charging cables or similar connectors that transfer power via a physical connection. One challenge with wireless power transfer is heat dissipation. During operation, losses within a wireless power transfer system produce heat, which can increase a temperature of an electronic device receiving power. Left unchecked, this heat can cause a hazardous situation that may damage a battery, the electronic device, or the wireless power transfer system. In some cases, fires may erupt that can injure users or damage property. Some techniques manage temperatures by limiting a power delivery current within the wireless power transfer system. This, however, limits an amount of power that can be transferred, which can inconvenience users by increasing a time associated with charging a device. Giving these factors, wireless power transfer performance may be limited by the heat dissipation that occurs during operation.

### BRIEF DESCRIPTION OF DRAWINGS

FIG. 1 illustrates an example operating environment using example wireless power transfer circuitry having a multi-path architecture.

FIG. 2 illustrates an example parallel arrangement of multiple power paths within a wireless power receiver.

FIG. 3 illustrates an example sequence flow diagram for managing heat dissipation within a wireless power receiver using multiple power paths.

FIG. 4 illustrates example implementations of a receiving element of a wireless power receiver using multiple power paths.

FIG. 5 illustrates an example parallel arrangement of multiple charging paths within a power transfer circuit.

FIG. 6 illustrates an example sequence flow diagram for managing heat dissipation within both a wireless power receiver and a power transfer circuit.

FIG. 7 illustrates another example arrangement of multiple power paths within a wireless power receiver and another example arrangement of multiple charging paths within a power transfer circuit.

FIG. 8 is a flow diagram illustrating an example operation of a wireless power receiver using multiple power paths.

FIG. 9 is a flow diagram illustrating an example operation of a power transfer circuit using multiple charging paths.

FIG. 10 illustrates an example wireless power transfer system including example wireless power transfer circuitry with a multi-path architecture.

### SUMMARY

An apparatus is disclosed that implements wireless power transfer circuitry having a multi-path architecture. The described techniques implement a wireless power receiver that includes multiple power paths, a power transfer circuit that includes multiple charging paths, or a combination thereof. By using multiple power paths within the wireless power receiver, each power path may provide at least a portion of a current that delivers power to the power transfer circuit. As a result, heat dissipation is distributed across a larger area compared to other designs that include a single power path. In some implementations, magnitudes of currents that flow through the power paths may be reduced to further decrease the amount of heat that is dissipated. In other implementations, different power paths may be operational at different times to control temperatures. Additionally or alternatively, the power transfer circuit includes multiple charging paths that deliver power to a load, such as a battery. A temperature control module can dynamically enable different combinations of the charging paths within the power transfer circuit to further manage the amount of heat that is dissipated within the wireless power receiver and the power transfer circuit. By distributing the heat across area or over time, temperatures may rise more slowly or maintain a lower average. Using the multi-path architecture, the wireless power transfer circuitry can manage temperatures without decreasing power levels such that a target amount of power is delivered to a load over a longer period of time. If the load includes a battery, this can increase a rate at which the battery charges.

In an example aspect, an apparatus is disclosed. The apparatus includes a wireless power receiver with at least one receiving element, at least one output power node, and two or more power paths having at least one power path configured to be selectively activated. The two or more power paths are coupled between the at least one receiving element and the at least one output power node.

In an example aspect, an apparatus is disclosed. The apparatus includes a wireless power receiver with at least one receiving element and at least one output power node. The at least one receiving element is configured to establish an electromagnetic coupling with a transmitting element. The wireless power receiver also includes two or more power means for delivering power to the at least one output power node. At least one power means of the two or more power means is selectively activated. The two or more power means are coupled between the at least one receiving element and the at least one output power node. The power is based on the electromagnetic coupling.

In an example aspect, a method for operating wireless power transfer circuitry with a multi-path architecture is disclosed. The method includes establishing, via at least one receiving element of a wireless power receiver, an electromagnetic coupling with a transmitting element. The wireless power receiver includes at least one output power node and two or more power paths coupled between the at least one receiving element and the at least one output power node. The method also includes selectively activating at least one power path of the two or more power paths. The method additionally includes delivering, based on the electromagnetic coupling, power to the at least one output power node using the at least one power path.

In an example aspect, an apparatus is disclosed. The apparatus includes a wireless power receiver and a power transfer circuit. The wireless power receiver includes at least one receiving element, at least one output power node, and at least one power path coupled between the at least one receiving element and the at least one output power node. The power transfer circuit includes at least one input charging node and an output charging node.. The at least one input charging node is coupled to the at least one output power node. The at least one power path comprises two or more charging paths coupled between the at least one input charging node and the output charging node. The two or more charging paths include a first charging path and a second charging path. The first charging path is configured to be in an active state during a first time interval and a second time interval. The second charging path is configured to selectively be in an inactive state during the first time interval and be in the active state during the second time interval

### DETAILED DESCRIPTION

During operation, power losses within a wireless power transfer system produce heat. Left unchecked, this heat can cause a hazardous situation that may damage a battery or load, an apparatus (e.g., an electronic device or a machine) that includes the battery or load, or the wireless power transfer system. An amount of heat dissipated depends on an amount of current produced by the wireless power transfer system for delivering power to the apparatus. Increasing the current can decrease an amount of time associated with charging the apparatus. However, a large current results in a large amount of heat dissipation, which can increase a temperature of the apparatus. To prevent the temperature from exceeding a threshold, the wireless power transfer system can decrease the current and therefore the amount of power delivered. Decreasing the current, however, inconveniences users by increasing the time associated with charging the apparatus. Giving these factors, wireless power transfer performance may be limited by the heat dissipation that occurs during operation.

If a wireless power receiver within the wireless power transfer system includes a single power path, heat is dissipated across a single area, which can cause the temperature to increase rapidly. To reduce heat dissipation without reducing power delivery, some techniques deliver power with a large voltage and a small current. Circuitry of some apparatuses, however, may not be rated to support the large voltage. Other techniques may use a voltage divider or charge pump to scale the wireless power transfer output voltage for the apparatus. However, these techniques may restrict a dynamic range of an input voltage and may change a design of a receiving element to generate the input voltage at a sufficient level.

In contrast, techniques implementing wireless power transfer circuitry having a multi-path architecture are described herein. The described techniques implement a wireless power receiver that includes multiple power paths, a power transfer circuit that includes multiple charging paths or a combination thereof. By using multiple power paths within the wireless power receiver, each power path may provide at least a portion of a current that delivers power to the power transfer circuit. As a result, heat dissipation is distributed across a larger area compared to other designs that include a single power path. In some implementations, magnitudes of currents that flow through the power paths may be reduced to further decrease the amount of heat that is dissipated. In other implementations, different power paths may be operational at different times to control temperatures. Additionally or alternatively, the power transfer circuit includes multiple charging paths that deliver power to a load, such as a battery. A temperature control module can dynamically enable different combinations of the charging paths within the power transfer circuit to further manage the amount of heat that is dissipated within the wireless power receiver and the power transfer circuit. By distributing the heat across area or over time, temperatures may rise more slowly or maintain a lower average. Using the multi-path architecture, the wireless power transfer circuitry can manage temperatures without decreasing power levels such that a target amount of power is delivered to a load over a longer period of time. If the load includes a battery, this can increase a rate at which the battery charges.

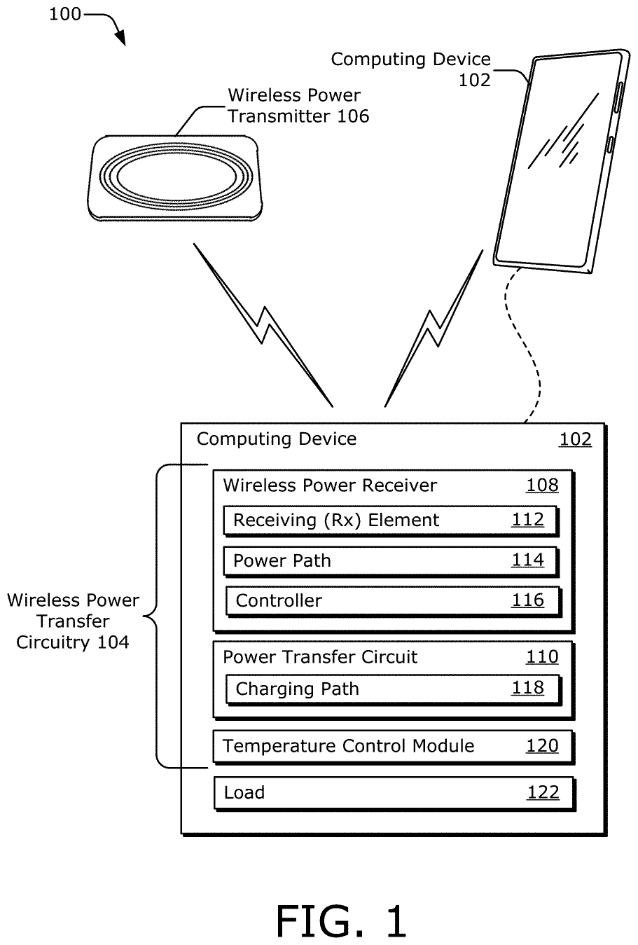

FIG. 1 illustrates an example environment 100 using example wireless power transfer circuitry having a multi-path architecture. In the depicted environment 100, a computing device 102 includes wireless power transfer circuitry 104 and a load 122. Power can be wirelessly transferred to the load 122 via a wireless power transmitter 106, a wireless power receiver 108 of the wireless power transfer circuitry 104, and a power transfer circuit 110 of the wireless power transfer circuitry 104. Although the computing device 102 is illustrated as a smart phone, the computing device 102 may be implemented as any suitable computing device, electronic device, or machine that is mobile or non-mobile. Example types of computing devices 102 include a cellular phone, gaming device, navigation device, media device, laptop computer, tablet computer, wearable computer, smart appliance or other internet of things (IoT) device, medical device, vehicle, or headphones. The load 122 can include a variable load, a load associated with other circuitry of the computing device 102, or a battery. Depending on the type of computing device 102, the battery may comprise a lithium-ion battery, a lithium polymer battery, a nickel-metal hydride battery, a nickel-cadmium battery, a lead acid battery, and so forth. In some cases, the battery can include multiple batteries, such as a main battery and a supplemental battery, and/or multiple battery cell combinations.

In operation, the wireless power transmitter 106 generates an alternating electromagnetic field, which wirelessly transfers power to the wireless power receiver 108. The alternating electromagnetic field has a frequency suitable for coupling the wireless power transmitter 106 and the wireless power receiver 108 together electromagnetically. The charging frequency may be, for example, on the order of kilohertz (kHz) to megahertz (MHz) (e.g., between 80 kHz and 300 kHz, or around 6.78 MHz). The power level provided wirelessly via the wireless power transmitter 106 and the wireless power receiver 108 is at a level sufficient to power the load 122. For example, the power level may be on the order of watts (W) to kilowatts (kW) (e.g., 1 W to 5 W for charging a battery of a mobile phone or 1 kW to 110 kW for charging a battery of a vehicle).

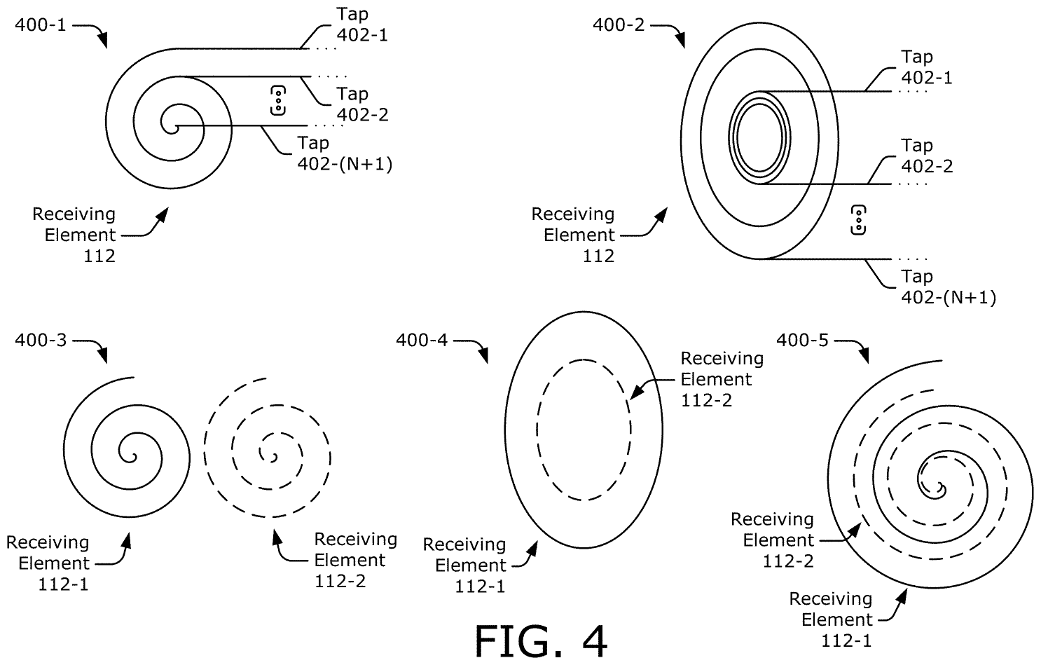

In example implementations, the wireless power receiver 108 is coupled between the wireless power transmitter 106 and the power transfer circuit 110. The wireless power receiver 108 includes at least one receiving (Rx) element 112, at least one power path 114 (or power train), and a controller 116. The receiving element 112 comprises an inductor or coil, which generates an induced voltage in response to the alternating electromagnetic field. A size of the receiving element 112, a shape of the receiving element 112, or a quantity of turns within the receiving element 112 is designed to induce a sufficient voltage for powering the load 122. Different implementations of the receiving element 112 are further described with respect to FIG. 4. Based on the induced voltage, a current is generated and provided to the one or more power paths 114.

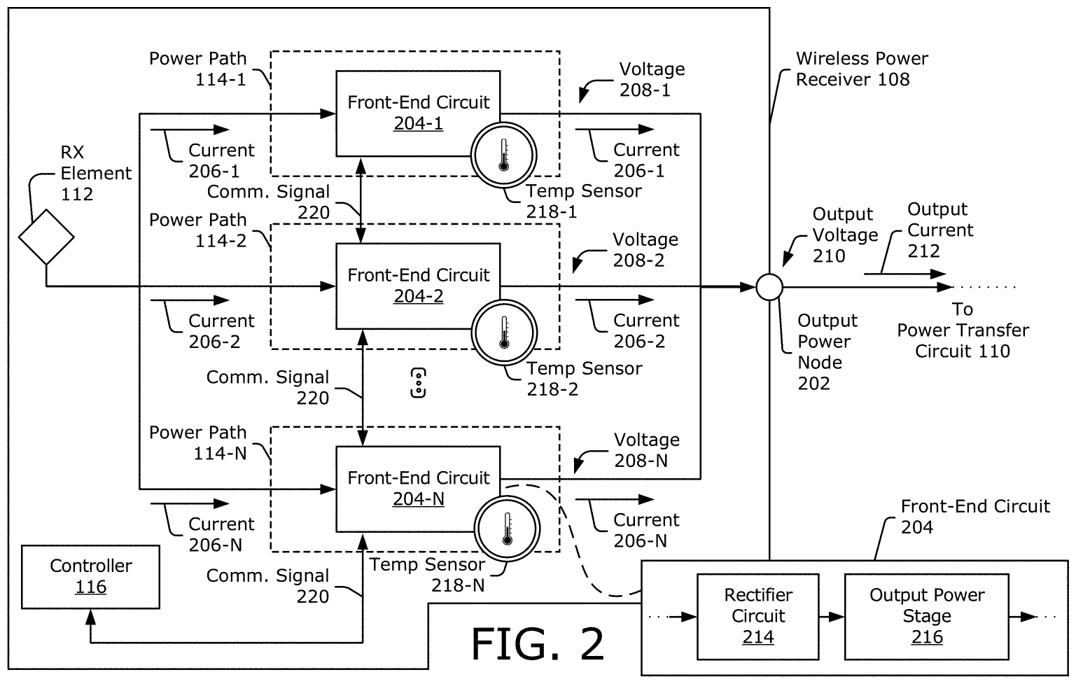

The power path 114 delivers power to the power transfer circuit 110. If the wireless power receiver 108 includes multiple power paths 114 that are in an active state, each active power path 114 delivers at least a portion of a total power to the power transfer circuit 110. In a balanced topology, individual power paths 114 deliver similar amounts of power to the power transfer circuit 110. Alternatively, in an unbalanced topology, different power paths 114 deliver different amounts of power to the power transfer circuit 110. The controller 116 can optionally control operational states of the multiple power paths 114 to balance power delivery and temperature during operation. The controller 116 can be implemented by a microcontroller, a system on chip (SoC), a processor, or hardware (e.g., separate circuitry, fixed logic circuitry, or hard-coded logic). Different implementations of the wireless power receiver 108 are further described with respect to FIGS. 2, 5, and 7.

The power transfer circuit 110 is coupled between the wireless power receiver 108 and the load 122. The power transfer circuit 110 includes at least one charging path 118, and the power transfer circuit 110 monitors and adjusts an amount of power delivered to the load 122 through the charging path 118. The power transfer circuit 110 can be a stand-alone component or a part of a power management integrated circuit (PMIC). The PMIC can include additional components, such as regulators, switches, watchdog timers, sensors, and so forth. If the power transfer circuit 110 includes multiple charging paths 118 that are in an active state, each active charging path 118 charges the load 122 using at least a portion of the total power provided via the wireless power receiver 108. In a balanced topology, individual charging paths 118 deliver similar amounts of power to the load 122. Alternatively, in an unbalanced topology, different charging paths 118 deliver different amounts of power to the load 122.

The computing device 102 can also include a temperature control module 120 that monitors respective temperatures of the one or more charging paths 118 and controls respective operations of the one or more charging paths 118. The temperature control module 120 can include computer instructions that are implemented by one or more processors. In some cases, the temperature control module 120 is external to the power transfer circuit 110 and is implemented by a SoC, an application processor, a main processor, a secondary processor, or a low-power digital signal processor of the computing device 102. In other cases, the temperature control module 120 is implemented within the power transfer circuit 110 or within the PMIC. Alternatively, the temperature control module 120 can be implemented within a microcontroller or hardware (e.g., separate circuitry, fixed logic circuitry, or hard-coded logic) that is internal or external to the power transfer circuit 110. In some implementations, a portion of the temperature control module 120 is implemented by the controller 116, or the controller 116 is in communication with the temperature control module 120 to enable the temperature control module 120 to monitor respective temperatures of the one or more power paths 114 and control respective operations of the one or more power paths 114. An example implementation of the wireless power receiver 108 is further described with respect to FIG. 2.

FIG. 2 illustrates an example parallel arrangement of multiple power paths 114 within the wireless power receiver 108. In the depicted configuration, the wireless power receiver 108 includes multiple power paths 114-1, 114-2 . . . 114-N, with N representing a positive integer greater than one. The wireless power receiver 108 also includes at least one receiving element 112 and at least one output power node 202. The power paths 114-1 to 114-N are coupled in parallel between the receiving element 112 and the output power node 202. Although not explicitly shown, the wireless power receiver 108 can be coupled to a power transfer circuit 110 having one or more charging paths 118.

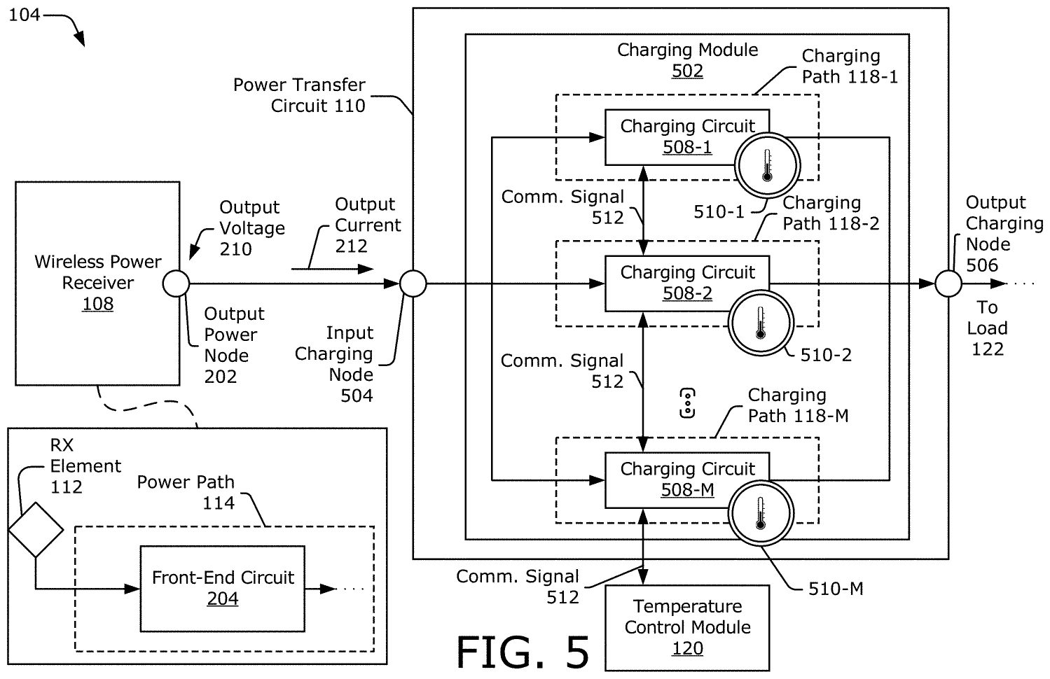

The power paths 114-1 to 114-N respectively include front-end circuits 204-1, 204-2 . . . 204-N. Each front-end circuit 204-1 to 204-N may comprise an application-specific integrated circuit (ASIC). In some implementations, the front-end circuit 204 includes a rectifier circuit 214 and an output power stage 216. The output power stage 216 can include a buck converter, a low-dropout (LDO) regulator, a switching regulator, or some other voltage or power conversion circuit. The rectifier circuit 214 generates a direct current (DC) power based on at least a portion of an alternating current (AC) power provided via the receiving element 112. The output power stage 216 regulates power delivery of the associated power path 114-1 to 114-N and provides a voltage and a current to the output power node 202. In some cases, the output power stage 216 dynamically adjusts the provided voltage based on an operational configuration of the power transfer circuit 110, as further described with respect to FIG. 5. The output power stage 216 can adjust, for example, the provided voltage in increments of approximately 20 millivolts (mV).

In other implementations, the front-end circuit 204 includes the rectifier circuit 214 and the output power stage 216 is implemented as a separate component that is coupled between the wireless power receiver 108 and the power transfer circuit 110 (e.g., coupled between the output power node 202 and an input charging node 504 of the power transfer circuit 110 shown in FIG. 5). Although not explicitly shown, the front-end circuit 204 may also include matching circuitry or a tuning circuit. The matching circuitry matches an input impedance of the front-end circuit 204 to an output impedance of the receiving element 112 to reduce losses associated with impedance mismatch. The tuning circuit can create a resonant circuit with the receiving element 112.

Respective currents 206-1, 206-2 . . . 206-N flow through the power paths 114-1 to 114-N from the receiving element 112 to the output power node 202. Magnitudes of the currents 206-1 to 206-N may be similar to or different from each other, depending on whether a balanced or unbalanced topology is implemented. The front-end circuits 204-1 to 204-N generate respective voltages 208-1, 208-2 . . . 208-N, which are similar to each other in this arrangement and are represented by an output voltage 210 at the output power node 202. At the output power node 202, the currents 206-1 to 206-N are combined to produce an output current 212. A total amount of power delivered via the power paths 114-1 to 114-N to the power transfer circuit 110 is based on the output voltage 210 and the output current 212. In some implementations, the power paths 114-1 to 114-N include respective temperature sensors 218-1, 218-2 . . . 218-N. Each temperature sensor 218-1 to 218-N measures a temperature of the corresponding front-end circuit 204-1 to 204-N. This temperature measurement is representative of a quantity of heat dissipated by the respective power path 114-1 to 114-N. The temperature sensors 218-1 to 218-N can be integrated within the front-end circuits 204-1 to 204-N or be implemented as external components (e.g., discrete components or integrated circuits).

With these temperature measurements, the controlling entity can coordinate or synchronize operations of the power paths 114-1 to 114-N to maintain a target power level for a longer period of time. In particular, the controlling entity activates different combinations of power paths 114-1 to 114-N at a time, such as at different time intervals. In the active state, a power path 114 delivers power to the output power node 202. In the inactive state, a power path 114 does not deliver power to the output power node 202. The controlling entity can also determine respective amounts of power generated by the power paths 114-1 to 114-N and adjust the power. For example, the controlling entity can specify target currents 206-1 to 206-N or voltages 208-1 to 208-N to be produced by the front-end circuits 204-1 to 204-N.

In other implementations in which the wireless power receiver 108 does not include the temperature sensors 218-1 to 218-N, the controller 116 can activate all of the power paths 114-1 to 114-N during a given time interval. By activating multiple power paths 114-1 to 114-N, each power path 114 may provide at least a portion of the output current 212 that delivers power to the power transfer circuit 110. As a result, heat dissipation is distributed across a larger area compared to other designs that include a single power path. Additionally, if the power paths 114-1 to 114-N are arranged in the parallel configuration illustrated in FIG. 2, magnitudes of the currents 206-1 to 206-N may be reduced to further decrease the amount of heat that is dissipated across each power path 114-1 to 114-N.

Although not explicitly shown, the wireless power receiver 108 can include a communication interface that enables one or more communication signals 220 to pass between individual front-end circuits 204-1 to 204-N or between the front-end circuits 204-1 to 204-N and the controller 116. In some cases, the communication interface enables one of the front-end circuits 204-1 to 204-N to act as a master and control operations of the other front-end circuits 204-1 to 204-N, which act as slaves. The communication signal 220 provides temperature measurements collected by the temperature sensors 218-1 to 218-N to a controlling entity, such as the controller 116 or to the master front-end circuit. Using the communication interface, the controlling entity sends the communication signals 220 to activate or deactivate one or more of the power paths 114-1 to 114-N and specify target outputs of the active power paths.

By disabling one or more of the multiple power paths 114-1 to 114-N, temperatures associated with the inactive power paths have an opportunity to decrease, while power continues to be delivered via the active power paths. An active state versus inactive state of different power paths can then be flip-flopped to manage temperatures. In this flip-flop scheme, the operational states of the power paths 114-1 to 114-N may switch based on a predetermined time period or based on the temperature measurements provided via the temperature sensors 218-1 to 218-N. If the temperature associated with an active power path exceeds a temperature threshold, the active power path is deactivated, and another inactive power path can be activated to continue delivering a same amount of power to the load 122.

In some situations, all of the power paths 114-1 to 114-N are in the active state during a first time interval. Because the currents 206-1 to 206-N combine to produce the output current 212 in the parallel configuration, the currents 206-1 to 206-N that flow through the active power paths 114-1 to 114-N are small relative to another wireless power receiver that uses a single power path to provide a single large current that is equivalent to the output current 212. With small currents 206-1 to 206-N, power losses associated with each power path 114-1 to 114-N are reduced, thereby reducing the overall heat dissipation within the wireless power receiver 108. If the wireless power receiver 108 includes two power paths 114-1 and 114-2 with a balanced topology, for example, the currents 206-1 and 206-2 can be approximately half of the output current 212. As a result, the amount of power loss within the power path 114-1 or 114-2 reduces by a factor of four relative to another wireless power receiver that has the same output current produced by a single power path. The wireless power receiver 108 shown in FIG. 2 can therefore dissipate less heat for a given level of power delivery, which enables the wireless power receiver 108 to maintain the level of power delivery for a longer period of time.

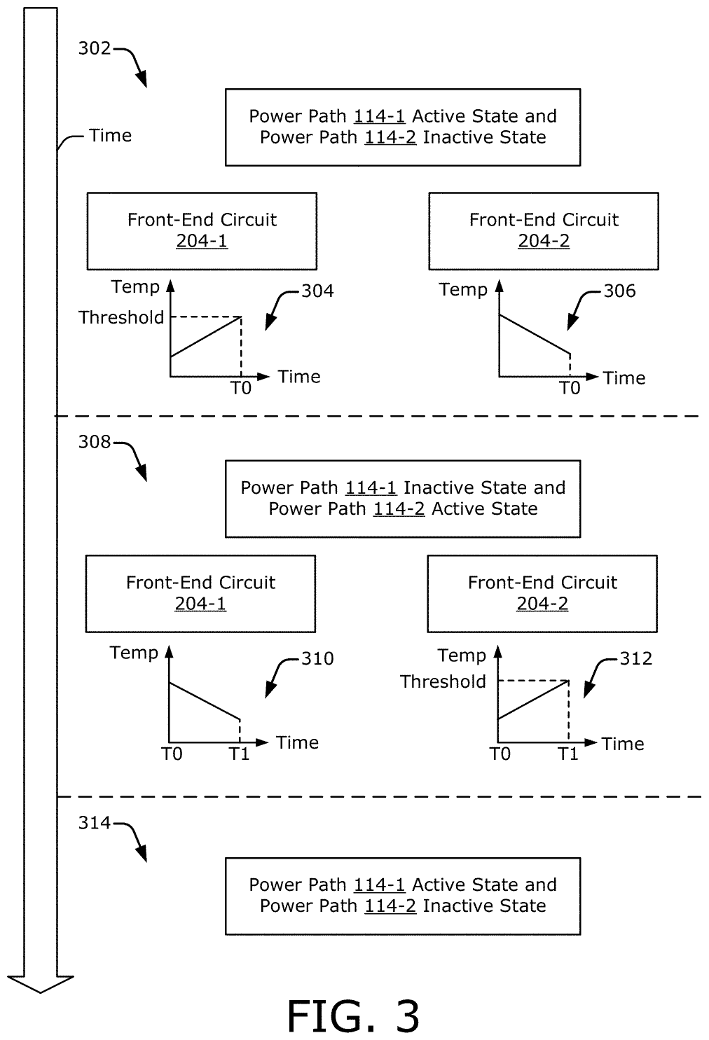

In other situations, a portion (or subset) of the power paths 114-1 to 114-N are in the active state while a remaining portion of the power paths 114-1 to 114-N are in the inactive state during a second time interval. In this case, larger currents 206-1 to 206-N may flow through the active power paths 114-1 to 114-N compared to the first time interval. However, temperatures may be managed by activating and deactivating different power paths 114-1 to 114-N such that a target amount of power is delivered to the power transfer circuit 110 while temperatures are maintained below a temperature threshold, as further described with respect to FIG. 3.

FIG. 3 illustrates an example sequence flow diagram for managing heat dissipation within the wireless power receiver 108 using multiple power paths 114-1 to 114-N, with time elapsing in a downward direction. In this case, the wireless power receiver 108 includes two power paths 114-1 and 114-2 implemented in the parallel configuration depicted in FIG. 2.

At 302, the power path 114-1 is in the active state and the power path 114-2 is in the inactive state. As such, the front-end circuit 204-1 produces power, and the front-end circuit 204-2 does not produce power. Because the front-end circuit 204-1 is active, a temperature of the front-end circuit 204-1 gradually increases over time, as shown at 304. In contrast, a temperature of the front-end circuit 204-2 gradually decreases over time, as shown at 306 (e.g., assuming that the front-end circuit 204-2 was previously active). At time T0, the temperature of the front-end circuit 204-1 reaches a predetermined threshold.

At 308, the controlling entity (e.g., the controller 116 or the master front-end circuit) causes the power path 114-1 to transition from the active state to the inactive state and causes the power path 114-2 to transition from the inactive state to the active state. Consequently, the temperature of the front-end circuit 204-1 decreases at 310 and the temperature of the front-end circuit 204-2 increases at 312 after time T0. At time T1, the temperature of the front-end circuit 204-2 reaches a predetermined threshold.

At 314, the controlling entity causes the power path 114-1 to transition from the inactive state to the active state and causes the power path 114-2 to transition from the active state to the inactive state. By dynamically enabling different front-end circuits 204-1 and 204-2, the wireless power receiver 108 uses the multiple power paths 114-1 to 114-N to control the heat dissipation over time and space. This enables the wireless power transfer circuitry 104 to deliver a target amount of power for longer durations relative to other circuitry that uses a single power path.

FIG. 4 illustrates example implementations 400-1, 400-2, 400-3, 400-4, and 400-5 of the receiving element 112 of the wireless power receiver 108 using multiple power paths 114-1 to 114-N. At 400-1, the receiving element 112 includes multiple taps 402-1, 402-2 . . . 402-(N+1). Although not shown, the power paths 114-1 to 114-N are coupled to different pairs of the taps 402-1 to 402-(N+1) such that a voltage difference between a respective pair of the taps 402-1 to 402-(N+1) delivers power to the respective coupled power path 114-1 to 114-N. The taps 402-1 to 402-(N+1) can be relatively evenly distributed across the receiving element 112 to generate similar voltages for the power paths 114-1 to 114-N. Alternatively, the taps 402-1 to 402-(N+1) can be relatively unevenly distributed across the receiving element 112 to generate different voltages for the power paths 114-1 to 114-N.

At 400-1, a density of turns of the receiving element 112 is evenly distributed. Alternatively, as shown at 400-2, the receiving element 112 has an uneven density of turns, with a higher concentration of turns occurring near a center of the receiving element 112 and a lower concentration of turns occurring near an outside of the receiving element 112 (e.g., where the circumference is larger). At 400-2, the receiving element 112 is represented with multiple ellipses instead of a spiral for simplicity. Generally, the taps 402-1 to 402-(N+1) are placed at different locations along these turns to generate target voltages for the power paths 114-1 to 114-N.

In some implementations, the receiving element 112 may comprise multiple receiving elements 112-1, 112-2 . . . 112-N that are respectively coupled to the power paths 114-1 to 114-N. The receiving elements 112-1 to 112-N may be similar or different in terms of quantities of turns, diameters, shapes, and so forth. At 400-3, two receiving elements 112-1 and 112-2 are shown for simplicity with a solid line and a dashed line, respectively. These receiving elements 112-1 and 112-2 are positioned side-by-side along an axis that is perpendicular to center axes of the receiving elements 112-1 and 112-2.

In other configurations, the receiving elements 112-1 and 112-2 are concentric with respect to each other and share a same center axis, as shown at 400-4. In some cases, the receiving elements 112-1 and 112-2 are stacked such that at least a portion of the receiving elements 112-1 and 112-2 overlap along a vertical dimension that is substantially in parallel to the center axis. In other configurations, the receiving element 112-2 is positioned inside of the receiving element 112-1, as shown at 400-4. At 400-5, at least portions of the receiving elements 112-1 and 112-2 are interleaved with each other.

Although the wireless power receiver 108 includes multiple power paths 114-1 to 114-N, some designs of the wireless power receiver 108 may have a size or silicon area that is similar to another wireless power receiver that includes a single power path. To achieve this, sizes of the front-end circuits 204-1 to 204-N can be reduced based on smaller current 206-1 to 206-N that flow through the power paths 114-1 to 114-N in the multi-path architecture. An area associated with the receiving element 112 can also remain relatively unchanged by using stacking techniques and adjusting a quantity of turns within the receiving element 112.

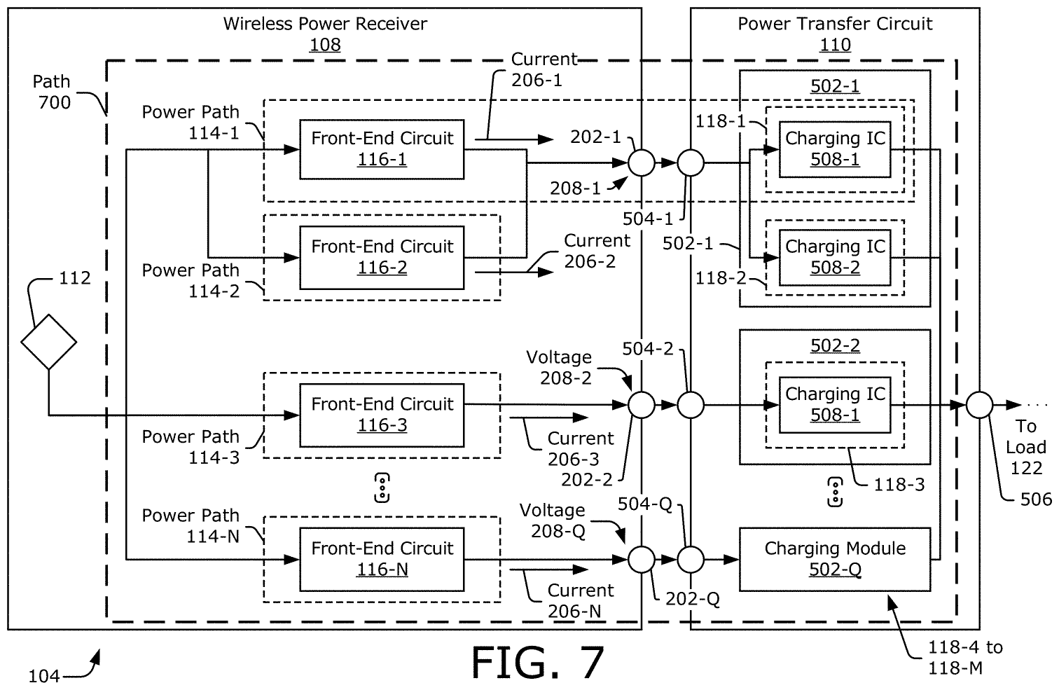

FIG. 5 illustrates an example parallel arrangement of multiple charging paths 118 within the power transfer circuit 110. For simplicity, the wireless power receiver 108 is shown to include one receiving element 112, one power path 114 with a front-end circuit 204, and one output power node 202. In other implementations, the wireless power receiver 108 can include multiple receiving elements 112 as described with respect to FIG. 4, multiple power paths 114-1 to 114-N as described with respect to FIG. 2, and/or multiple output power nodes 202-1 to 202-Q as described with respect to FIG. 7.

In the depicted configuration, the power transfer circuit 110 includes at least one charging module 502, at least one input charging node 504, and at least one output charging node 506. The charging module 502 is coupled between the input charging node 504 and the output charging node 506, and includes multiple charging paths 118-1, 118-2 . . . 118-M, with M representing a positive integer greater than one. The charging paths 118-1 to 118-M are coupled in parallel between the input charging node 504 and the output charging node 506. If the load 122 is a variable load, the charging paths 118-1 to 118-M represent different load paths within the wireless power transfer circuitry 104. Magnitudes of currents that flow from the charging paths 118-1 to 118-M to the output charging node 506 may be similar to or different from each other, depending on whether a balanced or unbalanced topology is implemented. As such, the charging paths 118-1 to 118-M can deliver similar amounts of power to the load 122 in the balanced topology or different amounts of power to the load 122 in the unbalanced topology.

The charging paths 118-1 to 118-M respectively include charging circuits 508-1, 508-2 . . . 508-M. Each charging circuit 508-1 to 508-M can comprise an integrated circuit (IC) and a variety of different power circuits, such as a linear-mode power circuit, a switch-mode power circuit, a charge pump (e.g., a divide-by-two charge pump or a divide-by-X charge pump with X representing a positive integer greater than two), a direct-charge power circuit, a capacitive divider, multiple power circuits of a similar type, and so forth. In some cases, the different charging circuits 508-1 to 508-M have different maximum input voltage thresholds. The wireless power receiver 108 provides the output voltage 210 that satisfies the lowest maximum input voltage threshold of the charging circuits 508-1 to 508-M that are active during a given time interval.

In some implementations, the charging circuits 508-1 to 508-M include respective temperature sensors 510-1 to 510-M. Each temperature sensor 510-1 to 510-M measures a temperature of the corresponding charging circuit 508-1 to 508-M. This temperature measurement is representative of a quantity of heat dissipated by the respective charging path 118-1 to 118-M.

Although not explicitly shown, the power transfer circuit 110 can include a communication interface that enables one or more communication signals 512 to pass between individual charging circuits 508-1 to 508-M or between the charging circuits 508-1 to 508-M and the temperature control module 120. In some cases, the communication interface enables one of the charging circuits 508-1 to 508-M to act as a master and control operations of the other charging circuits 508-1 to 508-M, which act as slaves. The communication signals 512 can provide temperature measurements collected by the temperature sensors 510-1 to 510-M to a controlling entity, such as the temperature control module 120 or to the master charging circuit.

Based on these temperature measurements, the controlling entity can coordinate or synchronize operations of the charging circuits 508-1 to 508-M. In particular, the controlling entity activates different combinations of the charging paths 118-1 to 118-M at a time. Similar to the power paths 114-1 to 114-N, a charging path 118 in the active state delivers power to the output charging node 506 while another charging path 118 in the inactive state does not deliver power to the output charging node 506. Using the communication interface, the controlling entity sends the communication signals 512 to activate or deactivate one or more of the charging paths 118-1 to 118-M.

By enabling two or more of the multiple charging paths 118-1 to 118-M, the active charging circuits 508-1 to 508-M operate at a relatively high efficiency, which reduces heat dissipation across the active charging circuits 508-1 to 508-M. As an example, one or more of the active charging circuits 508-1 to 508-M can operate at an efficiency level that is greater than approximately 93%. If the maximum input voltage thresholds of the active charging circuits 508-1 to 508-M differ or are at a relatively low voltage level that significantly reduces an operational efficiency of the front-end circuit 204, the wireless power receiver 108 operates at a relatively low efficiency to produce an output voltage 210 that meets the lowest maximum input voltage threshold of the active charging circuits 508-1 to 508-M, referred to herein as V1.

For example, the wireless power receiver 108 may operate at an efficiency level that is less than approximately 93% due to the output power stage 216 (of FIG. 2) regulating a DC voltage that is provided by the rectifier circuit 214 down to an output voltage 210 that is approximately equal to V1. The active charging circuits 508-1 to 508-M further regulate the output voltage 210 to a voltage that is associated with the load 122. A larger voltage drop across the output power stage 216 relative to a voltage drop across the active charging circuits 508-1 to 508-M places a thermal strain on the wireless power receiver 108 and results in additional heat dissipation occurring across the active power path 114 due to the low operational efficiency of the front-end circuit 204.

Alternatively, by enabling one of the multiple charging paths 118-1 to 118-M that has a maximum input voltage threshold V2 that is larger than V1, or a combination of multiple charging paths 118-1 to 118-M with a lowest maximum input voltage threshold of V3 that is also larger than V1, the thermal strain on the wireless power receiver 108 is transferred downstream to the charging module 502. In this case, the active charging circuits 508-1 to 508-M operate at relatively low efficiency (e.g., at an efficiency level that is less than approximately 93%), which increases heat dissipation within the charging module 502. In contrast, the wireless power receiver 108 operates at relatively high efficiency (e.g., at an efficiency level that is greater than approximately 93%), which reduces heat dissipation within the wireless power receiver 108.

As an example, the output power stage 216 of the front-end circuit 204 regulates the DC voltage down to an output voltage 210 that is approximately equal to V2 or V3. The active charging circuits 508-1 to 508-M further regulate the output voltage 210 to a voltage that is associated with the load 122. A larger voltage drop across the active charging circuits 508-1 to 508-M relative to a voltage drop across the output power stage 216 places a thermal strain on the power transfer circuit 110 and results in additional heat dissipation occurring across the active charging paths 118-1 to 118-M due to the low operational efficiency of the active charging circuits 508-1 to 508-M.

By disabling one or more of the multiple charging paths 118-1 to 118-M, however, temperatures associated with the inactive charging paths have an opportunity to decrease, while power continues to be delivered via the active charging paths. The active state versus inactive state of different charging paths can then be flip-flopped to manage temperatures across the charging module 502. In this flip-flop scheme, the operational states of the charging paths 118-1 to 118-M may switch based on a predetermined time period or based on the temperature measurements provided via the temperature sensors 510-1 to 510-M. If the temperature associated with an active charging path exceeds a temperature threshold, the active charging path is deactivated and another inactive charging path can be activated. Additionally or alternatively, the combination of active charging paths 118-1 to 118-M can be adjusted to decrease the lowest maximum input voltage threshold of the combination and transfer the thermal strain upstream to the wireless power receiver 108.

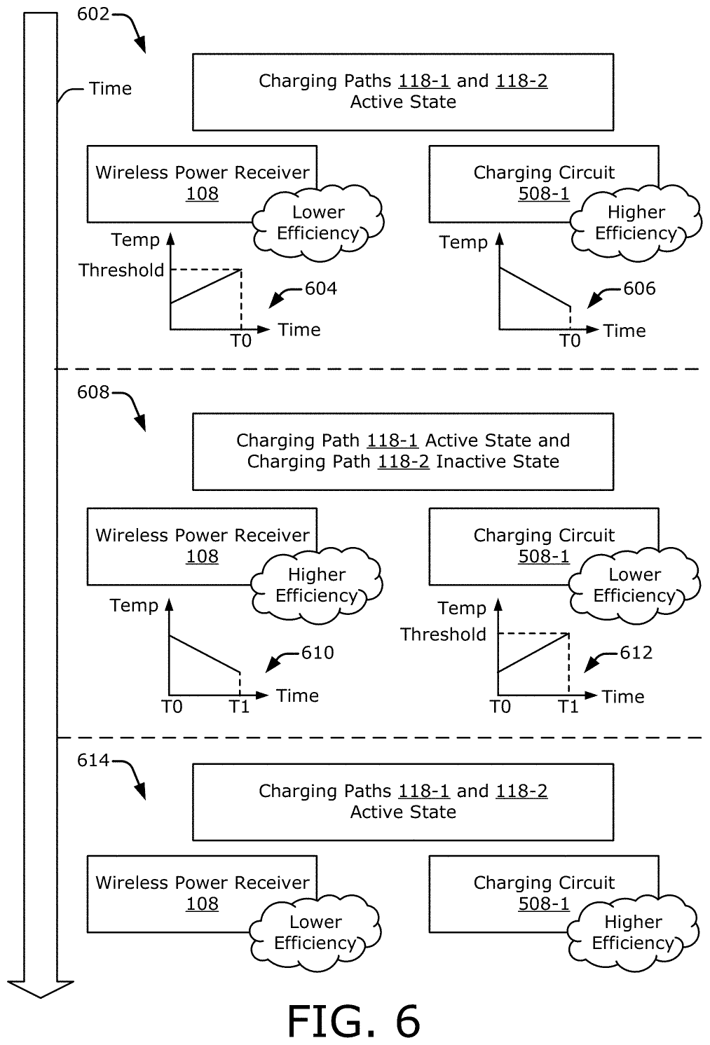

Temperatures can therefore be managed by switching between different combinations of active charging paths 118-1 to 118-M and by dynamically placing the thermal strain upstream at the wireless power receiver 108 or downstream at the power transfer circuit 110. In this way, a target amount of power can continue to be delivered to the load 122 while temperatures are maintained below a temperature threshold, as further described with respect to FIG. 6.

FIG. 6 illustrates an example sequence flow diagram for managing heat dissipation within both the wireless power receiver 108 and the power transfer circuit 110, with time elapsing in a downward direction. In this case, the wireless power receiver 108 includes one power path 114, and the power transfer circuit 110 includes two charging paths 118-1 and 118-2 implemented in the parallel configuration shown in FIG. 5. In this example, the charging path 118-1 has a maximum voltage threshold of V2, and the charging path 118-2 has a maximum voltage threshold of V1, which is less than V2. A target output voltage of the power transfer circuit 110 at the output charging node 506 is V4, which is associated with a voltage of the load 122 and is less than both V1 and V2. Over time, respective operating efficiencies of the wireless power receiver 108 and the charging circuit 508-1 vary based on the states of the charging paths 118-1 and 118-2, as further described below.

At 602, the charging paths 118-1 and 118-2 are in the active state. As such, the wireless power receiver 108 operates at a relatively lower efficiency to produce an output voltage 210 approximately equal to V1. In this case, the charging circuit 508-1 operates at a relatively high efficiency and regulates the voltage from V1 to V4. Due to the lower efficiency of the wireless power receiver 108, however, the temperature of the front-end circuit 204 of the wireless power receiver 108 increases over time, as shown at 604. In contrast, a temperature of the charging circuit 508-1 gradually decreases over time, as shown at 606, (e.g., assuming that the charging circuit 508-1 was previously active) or increases at a smaller rate than that of the front-end circuit 204. At time T0, the temperature of the front-end circuit 204 reaches a predetermined threshold.

At 608, the controlling entity (e.g., the temperature control module 120 or the master charging circuit) causes the charging path 118-2 to transition from the active state to the inactive state. In this case, the wireless power receiver 108 operates at a higher efficiency relative to the efficiency at 602 and produces an output voltage 210 that is approximately equal to V2. This results in the temperature of the front-end circuit 204 decreasing after T0, as shown at 610, or increasing at a smaller rate than the charging circuit 508-1. Due to the increase in the output voltage 210, however, the charging circuit 508-1 operates at a lower efficiency relative to the efficiency at 602 and regulates the voltage from V2 to V4. Consequently, the thermal strain is transferred from the wireless power receiver 108 to the charging circuit 508-1, and this transfer results in the temperature of the charging circuit 508-1 increasing after time T0, as shown at 612. At time T1, the temperature of the charging circuit 508-1 reaches a predetermined threshold.

At 614, the controlling entity causes the charging path 118-2 to transition from the inactive state to the active state such that the wireless power receiver 108 operates at the lower efficiency relative to the efficiency at 608 and the charging circuit 508-1 operates at the higher efficiency relative to the efficiency at 608. By dynamically moving the thermal strain upstream to the wireless power receiver 108 or downstream to the power transfer circuit 110, the temperature control module 120 can adjust the heat distribution across time and space to sustain a target amount of power delivery for longer durations.

Although the efficiency of the charging circuit 508-1 is shown to increase and decrease over time, in some cases both the higher efficiency and the lower efficiency are above a target efficiency level. In general, the controlling entity can select and activate the appropriate charging circuit 508-1 to 508-M to achieve a target cumulative efficiency and a target heat dissipation.

FIG. 7 illustrates another example arrangement of the multiple power paths 114-1 to 114-N within the wireless power receiver 108 and another example arrangement of the multiple charging paths 118-1 to 118-M within the power transfer circuit 110. In the depicted configuration, the wireless power receiver 108 includes multiple output power nodes 202-1, 202-2 . . . 202-Q and the power transfer circuit 110 includes multiple input charging nodes 504-1, 504-2 . . . 504-Q, with Q representing a positive integer greater than one.

At least a portion of the power paths 114-1 to 114-N may be balanced or unbalanced within the wireless power receiver 108. In this arrangement, the currents 206-1 to 206-N may be similar to or different from each other. The voltages 208-1 to 208-N may also be similar to or different from each other. The controller 116 activates or deactivates the power paths 114-1 to 114-N such that one of the output power nodes 202-1 to 202-Q delivers power to the power transfer circuit 110 at a given time. In some implementations, a portion of the power paths 114-1 to 114-N are in a parallel configuration. For example, the power paths 114-1 and 114-2 are coupled together in parallel between the receiving element 112 and the output power node 202-1. For power paths 114-1 to 114-N in the parallel arrangement, one or more of these power paths 114-1 to 114-N can be in the active state at a given time. Two or more of these parallel power paths 114-1 to 114-N can also dynamically flip-flop between being in the active state or the inactive state.

The power transfer circuit 110 is shown to include multiple charging modules 502-1, 502-2 . . . 502Q, each of which are coupled between the output charging node 506 and respective input charging nodes 504-1 to 504-Q. Each of the multiple charging modules 502-1 to 502-Q can be used to charge the load 122 at different times. In some cases, one of the charging modules 502-1 to 502-Q may be implemented as a master charger while the others are slave chargers. The charging modules 502-1 to 502-Q can operate with similar or different levels of efficiency. If the power paths 114-1 to 114-N are unbalanced and provide different amounts of power at the output power nodes 202-1 to 202-Q, a charging module 502-1 to 502-Q with a higher efficiency can be coupled to an output power node 202-1 to 202-Q that delivers a larger amount of power.

In the depicted configuration, a portion of the charging modules 502-1 to 502-Q include multiple charging paths and another portion of the charging modules 502-1 to 502-Q respectively include a single charging path. For example, the charging module 502-1 includes two charging paths 118-1 and 118-2 and the charging module 502-2 includes a charging path 118-3. At least a portion of the charging paths 118-1 to 118-M may be balanced or unbalanced within the power transfer circuit 110.

If power is delivered via the output power node 202-1, the temperature control module 120 can cause both charging circuits 508-1 and 508-2 to be in the active state to place the thermal strain upstream across the power paths 114-1 and/or 114-2. Alternatively, the temperature control module 120 can cause one of the charging circuits 508-1 and 508-2 to be in the active state and another of the charging circuits 508-1 and 508-2 to be in the inactive state to place the thermal strain downstream across the charging module 502-1.

Although the power paths 114-1 to 114-N and the charging paths 118-1 to 118-M are illustrated and described separately, both the power paths 114-1 to 114-N and the charging paths 118-1 to 118-M are electrical paths that can transfer power from one node to another node. Generally, at least one path 700 exists between the receiving element 112 and the load 122 such that the path 700 is disposed in both the wireless power receiver 108 and the power transfer circuit 110. In the context of delivering power from the receiving element 112 to the load 122, different combinations of power paths 114-1 to 114-N and charging paths 118-1 to 118-M within the path 700 are selectively activated to power the load 122. Because the path 700 is an electrical path that transfers power between two nodes, the path 700 can be referred to as a power path 114 or a charging path 118. As such, a power path 114 can be considered to include one or more charging paths 118, and a charging path 118 can be considered to include one or more power paths 114. As an example, the power path 114-1 is shown to include the charging path 118-1 in FIG. 7.

In general, any combination of multiple power paths 114-1 to 114-N and/or the multiple charging paths 118-1 to 118-M are possible within the wireless power receiver 108 and the power transfer circuit 110 to manage heat dissipation and sustain a target amount of power delivery for a longer period of time, thereby increasing a rate at which power is delivered to the load 122 and improving wireless power transfer efficiency.

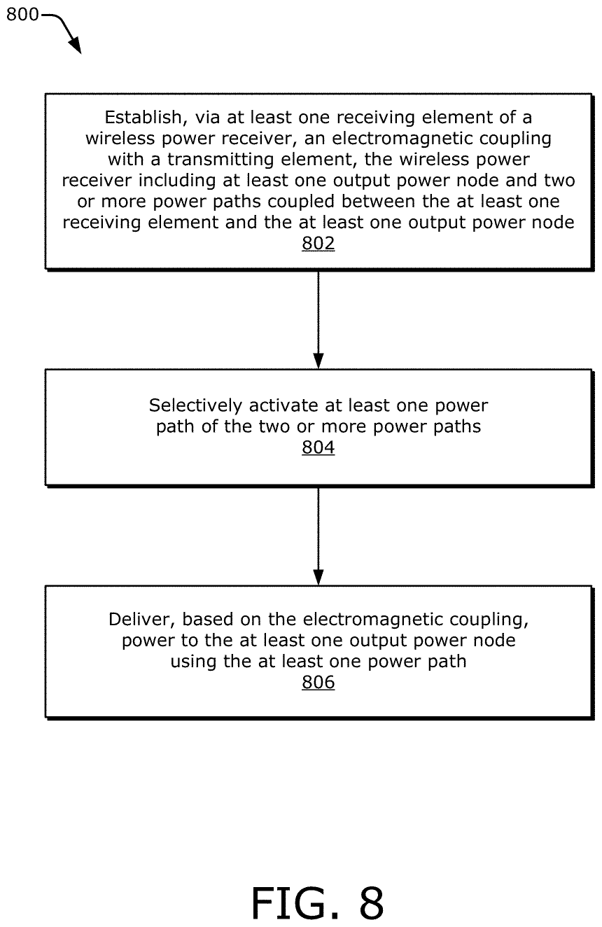

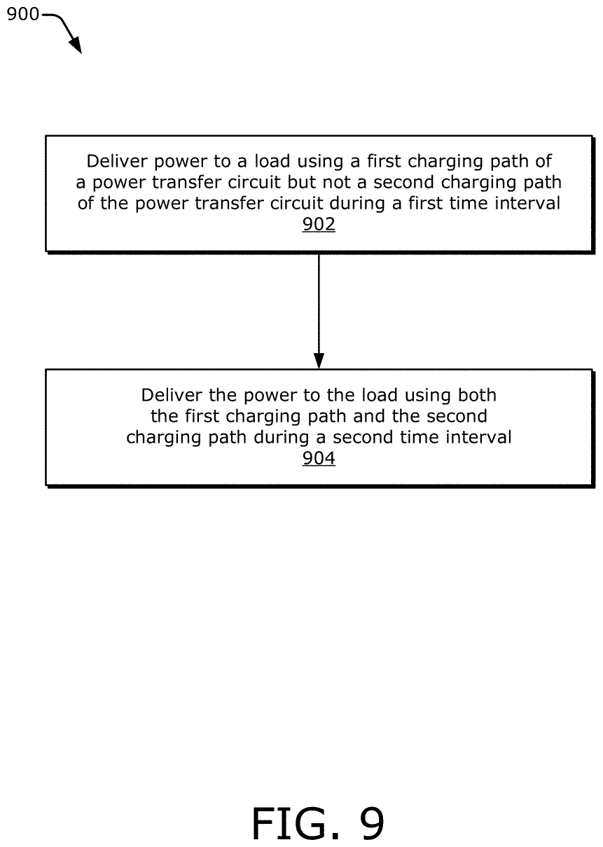

FIGS. 8 and 9 are flow diagrams illustrating example processes 800 and 900 for operating wireless power transfer circuitry with a multi-path architecture. The processes 800 and 900 are described in the form of sets of blocks 802-806 and 902-904 that specify operations that can be performed. However, operations are not necessarily limited to the order shown in FIGS. 8 and 9 or described herein, for the operations may be implemented in alternative orders or in fully or partially overlapping manners. Operations represented by the illustrated blocks of the processes 800 and 900 may be performed by wireless power transfer circuitry 104 (e.g., of FIG. 1). More specifically, the operations of the process 800 may be performed by a wireless power receiver 108 as shown in FIG. 1, 2, 5, or 7. The operations of the process 900 may be performed by a power transfer circuit 110 as shown in FIG. 1, 5, or 7.

FIG. 8 is a flow diagram illustrating, as the process 800, an example operation of a wireless power receiver using multiple power paths. At 802, an electromagnetic coupling is established with a transmitting element via at least one receiving element of a wireless power receiver. The wireless power receiver includes at least one output power node and two or more power paths coupled between the at least one receiving element and the at least one output power node. For example, the at least one receiving element 112 of the wireless power receiver 108 establishes an electromagnetic coupling with a transmitting element of the wireless power transmitter 106. The wireless power receiver 108 includes at least one output power node 202 and two or more power paths 114-1 to 114-N. The two or more power paths 114-1 to 114-N are coupled between the at least one receiving element 112 and the at least one output power node 202, as shown in FIG. 2. In one example, the power paths 114-1 and 114-2 are in a parallel arrangement between the receiving element 112 and the output power node 202-1, as shown in FIG. 7. In another example, the power paths 114-1 and 114-3 are coupled between the receiving element 112 and different output power nodes 202-1 and 202-2, as shown in FIG. 7. In yet another example, the power paths 114-1 and 114-2 are coupled between different receiving elements, such as the receiving elements 112-1 and 112-2 (of FIG. 4), and the output power node 202-1.

At 804, at least one power path of the two or more power paths is selectively activated. For example, the controller 116 selectively activates at least one power path of the two or more power paths 114-1 to 114-N. In the parallel configuration shown in FIG. 2, the controller 116 can cause one or more of the power paths 114-1 to 114-N to be in the active state during a given time interval. In some cases, the controller 116 causes different combinations of the power paths 114-1 to 114-N to be in the active state during different time intervals.

At 806, power is delivered to the at least one output power node using the at least one power path. The power is based on the electromagnetic coupling. For example, the wireless power receiver 108 delivers, based on the electromagnetic coupling, power to the output power node 202-1 using the power path 114-1 of FIG. 7. In this example, the power path 114-1 is selectively in the active state. Alternatively, multiple power paths, such as the power paths 114-1 and 114-2 of FIG. 7, are in the active state to deliver the power to the output node 202-1. Accordingly, each of the power paths 114-1 to 114-2 delivers a portion of the power to the output node 202-1. With multiple power paths 114-1 to 114-N, heat dissipation can be distributed over time and space within the wireless power receiver 108.

FIG. 9 is a flow diagram illustrating, as the process 900, an example operation of a power transfer circuit using multiple charging paths. At 902, power is delivered to a load using a first charging path of a power transfer circuit but not a second charging path of the power transfer circuit during a first time interval. For example, the power transfer circuit 110 delivers power to the load 122 using the charging path 118-1 of FIG. 7 but not the charging path 118-2 during a first time interval, such as the time interval associated with 608 of FIG. 6.

At 904, the power is delivered to the load using both the first charging path and the second charging path during a second time interval. For example, the power transfer circuit 110 delivers the power to the load 122 using both the charging paths 118-1 and 118-2 of FIG. 7 during a second time interval, such as the time interval associated with 602 or 614 of FIG. 6. In this way, temperatures can be managed by activating different combinations of charging paths and by dynamically placing the thermal strain upstream at the wireless power receiver 108 or downstream at the power transfer circuit 110. Consequently, a target amount of power can continue to be delivered to the load 122 while temperatures are maintained below a temperature threshold.

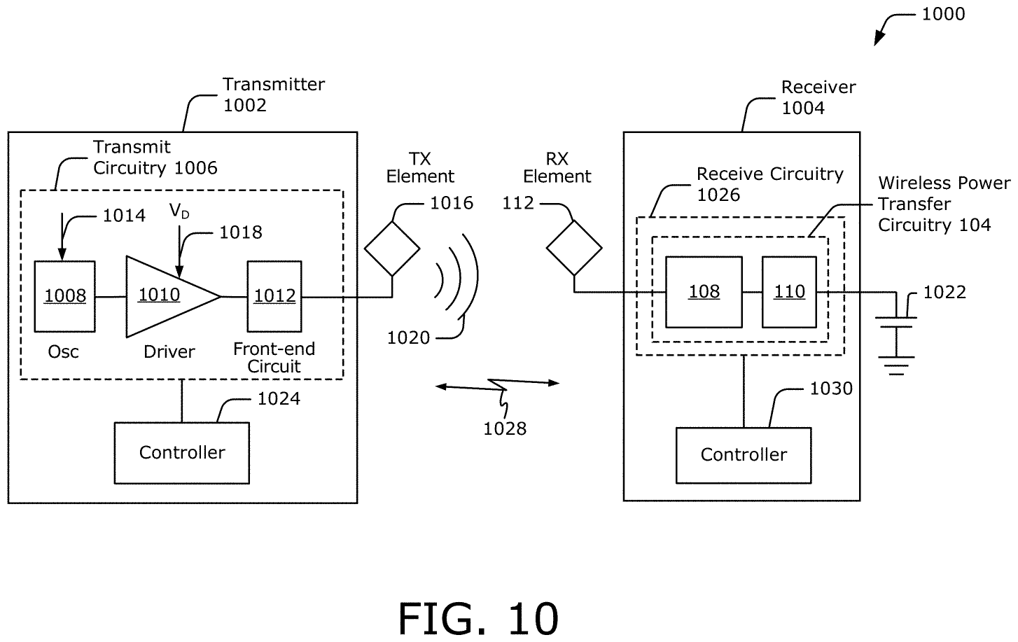

FIG. 10 illustrates an example wireless power transfer system 1000 including example wireless power transfer circuitry 104 having a multi-path architecture. The system 1000 includes a transmitter 1002 and a receiver 1004. The transmitter 1002 and the receiver 1004 may correspond to or be included as part of, respectively, the wireless power transmitter 106 and the wireless power receiver 108 of FIG. 1.

The transmitter 1002 includes transmit circuitry 1006 having an oscillator 1008, a driver circuit 1010, and a front-end circuit 1012. The oscillator 1008 generates an oscillator signal at a desired frequency that can be adjusted in response to a frequency control signal 1014. The oscillator 1008 provides the oscillator signal to the driver circuit 1010. The driver circuit 1010 drives the power transmitting element 1016 at, for example, a resonant frequency of the power transmitting element 1016 based on an input voltage signal (V_{D}) 1018. The driver circuit 1010 can be a switching amplifier configured to receive a square wave from the oscillator 1008 and output a sine wave.

The front-end circuit 1012 for the transmitter 1002 can include a filter circuit (not shown) that filters out harmonics or other unwanted frequencies. The front-end circuit 1012 can also include a matching circuit or a tuning circuit. The matching circuit matches an output impedance of the transmitter 1002 to an input impedance of the power transmitting element 1016. The tuning circuit creates a resonant circuit with the power transmitting element 1016. As a result of driving the power transmitting element 1016, the power transmitting element 1016 generates a wireless field 1020 to wirelessly output power at a level sufficient for charging a battery 1022 (e.g., powering the load 122 of FIG. 1).

The transmitter 1002 can further include a controller 1024 operably coupled to the transmit circuitry 1006 to control one or more aspects of the transmit circuitry 1006, or accomplish other operations relevant to managing the wireless transfer and powering the receiver 1004. The controller 1024 may be a micro-controller or a processor, and may be implemented as an application-specific integrated circuit (ASIC). The controller 1024 can be operably connected, directly or indirectly, to each component of the transmit circuitry 1006. In this way, the controller 1024 can receive information from each of the components of the transmit circuitry 1006 and perform calculations based on the received information. The controller 1024 can also generate control signals (e.g., the control signal 1014) for each of the components to adjust the operation of that component. As such, the controller 1024 adjusts or manages the power transfer for powering the receiver 1004. The transmitter 1002 may further include a memory (not shown), which stores data. For example, the data may comprise instructions for causing the controller 1024 to perform particular functions, such as those related to management of wireless power transfer.

The receiver 1004 may include receive circuitry 1026 with wireless power transfer circuitry 104 having a multi-path architecture. In particular, the wireless power transfer circuitry 104 includes a wireless power receiver 108 with at least one power path 114 and a power transfer circuit 110 with at least one charging path 118. Depending on the implementation, the wireless power transfer circuitry 104 can include two or more power paths 114 (as shown in FIGS. 2 and 7), two or more charging paths 118 (as shown in FIGS. 5 and 7), or two or more power paths 114 and charging paths 118 (as shown in FIG. 7). The receiver 1004 and the transmitter 1002 may additionally communicate on a separate communication channel 1028, e.g., Bluetooth™, ZigBee™, or cellular. The receiver 1004 and the transmitter 1002 may alternatively communicate via in-band signaling using characteristics of the wireless field 1020.

Further, the receiver 1004 determines whether an amount of power received from the transmitter 1002 is appropriate for charging the battery 1022 or powering the load. In certain aspects, the transmitter 1002 may be configured to generate a predominantly non-radiative field with a direct field coupling coefficient (k) for providing energy transfer. The receiver 1004 directly couples to the wireless field 1020 and generates an output power for storing or consumption by the battery 1022 (or load), which is coupled to the output of the receive circuitry 1026.

The receiver 1004 may further include a controller 1030, which is configured similarly to the transmit controller 1024 for one or more wireless power management aspects of the receiver 1004. The controller 1030 can include the controller 116 and the temperature control module 120 of FIG. 1. In some implementations, the controller 1030 dynamically controls operational states of individual power paths 114 and/or the charging paths 118 based on respective temperatures of these paths. In other implementations, all of these paths operate in an active state for a given time interval. The receiver 1004 may further include a memory (not shown), which is configured to store data, such as instructions for causing the controller 1030 to perform particular functions, such as those related to management of wireless power transfer and heat dissipation within the receive circuitry 1026. The transmitter 1002 and the receiver 1004 may be separated by a distance and configured according to a mutual resonant relationship to minimize transmission losses between the transmitter 1002 and the receiver 1004.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Further, items represented in the accompanying figures and terms discussed herein may be indicative of one or more items or terms, and thus reference may be made interchangeably to single or plural forms of the items and terms in this written description. Finally, although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

What is claimed is:

1. An apparatus comprising:
a wireless power receiver including:
at least one receiving element;
at least one output power node; and
two or more power paths having at least one power path configured to be selectively activated, the two or more power paths coupled between the at least one receiving element and the at least one output power node.

2. The apparatus of claim 1, wherein:
the at least one receiving element is configured to establish an electromagnetic coupling with a transmitting element; and
the two or more power paths are configured to deliver power to the at least one output power node based on the electromagnetic coupling.

3. The apparatus of claim 2, wherein:
a first power path of the two or more power paths is configured to deliver a first amount of the power to the at least one output power node;
a second power path of the two or more power paths is configured to deliver a second amount of the power to the at least one output power node; and
the first amount of the power and the second amount of the power are substantially similar.

4. The apparatus of claim 2, wherein:
a first power path of the two or more power paths is configured to deliver a first amount of the power to the at least one output power node;
a second power path of the two or more power paths is configured to deliver a second amount of the power to the at least one output power node; and
the first amount of the power and the second amount of the power are relatively different.

5. The apparatus of claim 1, wherein the wireless power receiver includes a controller coupled to the two or more power paths, the controller configured to:
determine temperatures associated with the two or more power paths; and
selectively cause the at least one power path to be in an active state or an inactive state based on the temperatures.

6. The apparatus of claim 1, wherein:
the at least one output power node includes a first output power node; and
the two or more power paths are coupled in parallel between the at least one receiving element and the first output power node.

7. The apparatus of claim 6, wherein the two or more power paths are jointly configured to be in an active state during a given time interval.

8. The apparatus of claim 1, further comprising:
a load; and
a power transfer circuit coupled between the wireless power receiver and the load via the two or more power paths, the power transfer circuit including:
a first input charging node coupled to a first output power node of the at least one output power node; and
an output charging node coupled to the load;
wherein the two or more power paths comprise two or more charging paths coupled in parallel between the first input charging node and the output charging node.

9. The apparatus of claim 8, wherein the two or more charging paths include:
a first charging path configured to be in an active state during a first time interval and a second time interval; and
a second charging path configured to selectively:
be in the active state during the first time interval; and
be in an inactive state during the second time interval.

10. The apparatus of claim 9, further comprising:
a temperature control module coupled to the two or more charging paths, the temperature control module configured to:
determine a temperature associated with the first charging path; and
selectively cause the second charging path to be in the active state or the inactive state based on the temperature.

11. The apparatus of claim 1, wherein:
the at least one output power node includes a first output power node and a second output power node;
a first power path of the two or more power paths is coupled between the at least one receiving element and the first output power node; and
a second power path of the two or more power paths is coupled between the at least one receiving element and the second output power node.

12. The apparatus of claim 11, wherein:
the first power path is configured to selectively be in:
an active state during a first time interval; and
an inactive state during a second time interval; and
the second power path is configured to selectively be in:
the inactive state during the first time interval; and
the active state during the second time interval.

13. The apparatus of claim 11, further comprising:
a load; and
a power transfer circuit coupled between the wireless power receiver and the load, the power transfer circuit including:
a first input charging node coupled to the first output power node;
a second input charging node coupled to the second output power node;
an output charging node coupled to the load;
a first charging path coupled between the first input charging node and the output charging node; and
a second charging path coupled between the second input charging node and the output charging node.

14. The apparatus of claim 1, wherein:
the at least one receiving element comprises an inductor with a first tap, a second tap, and a third tap; and
the two or more power paths include:
a first power path coupled to the first tap and the second tap; and
a second power path coupled to the second tap and the third tap.

15. The apparatus of claim 1, wherein:
the at least one receiving element includes a first receiving element and a second receiving element; and
the two or more power paths include:
a first power path coupled to the first receiving element; and
a second power path coupled to the second receiving element.

16. An apparatus comprising:
a wireless power receiver including:
at least one receiving element configured to establish an electromagnetic coupling with a transmitting element;
at least one output power node; and
two or more power means for delivering power to the at least one output power node, at least one power means of the two or more power means selectively activated, the two or more power means coupled between the at least one receiving element and the at least one output power node, the power based on the electromagnetic coupling.

17. The apparatus of claim 16, wherein:
the two or more power means are individually activated during different time intervals; or
the two or more power means are both activated during a given time interval.

18. The apparatus of claim 16, further comprising:
a load; and
a power transfer circuit coupled between the wireless power receiver and the load, the power transfer circuit including:
at least one input charging node coupled to the at least one output power node; and
an output charging node coupled to the load,
wherein the two or more power means comprise two or more charging means for charging the load using the power, the two or more charging means coupled between the at least one input charging node and the output charging node.

19. The apparatus of claim 18, further comprising:
control means for causing different combinations of the two or more power means and the two or more charging means to selectively be in an active state or an inactive state based on temperatures associated with the wireless power receiver and the power transfer circuit.

20. A method comprising:
establishing, via at least one receiving element of a wireless power receiver, an electromagnetic coupling with a transmitting element, the wireless power receiver including at least one output power node and two or more power paths coupled between the at least one receiving element and the at least one output power node;
selectively activating at least one power path of the two or more power paths; and
delivering, based on the electromagnetic coupling, power to the at least one output power node using the at least one power path.

21. The method of claim 20, wherein:
the two or more power paths include a first power path and a second power path;
the activating of the at least one power path comprises activating both the first power path and the second power path during a given time interval; and
the delivering of the power comprises:
delivering a first portion of the power to the at least one output power node using the first power path during the given time interval; and
delivering a second portion of the power to the at least one output power node using the second power path during the given time interval.

22. The method of claim 20, wherein:
the two or more power paths include a first power path and a second power path;
the activating of the at least one power path comprises:
activating the first power path during a first time interval; and
activating the second power path during a second time interval; and
the delivering of the power comprises:
delivering the power during the first time interval using the first power path but not the second power path; and
delivering the power during the second time interval using the second power path but not the first power path.

23. The method of claim 20, further comprising:
delivering the power to a load using a first charging path of a power transfer circuit but not a second charging path of the power transfer circuit during a first time interval; and
delivering the power to the load using both the first charging path and the second charging path during a second time interval,
wherein the two or more power paths comprise the first charging path and the second charging path.

24. The method of claim 23, further comprising:
determining respective temperatures associated with the two or more power paths, the first charging path, and the second charging path; and
causing the two or more power path, the first charging path, and the second charging path to selectively be in an active state or an inactive state based on the respective temperatures.

25. An apparatus comprising:
a wireless power receiver including:
at least one receiving element;
at least one output power node; and
at least one power path coupled between the at least one receiving element and the at least one output power node; and
a power transfer circuit including:
at least one input charging node coupled to the at least one output power node; and
an output charging node,
wherein the at least one power path comprises two or more charging paths coupled between the at least one input charging node and the output charging node, the two or more charging paths including:
a first charging path configured to be in an active state during a first time interval and a second time interval; and
a second charging path configured to selectively be in an inactive state during the first time interval and be in the active state during the second time interval.

26. The apparatus of claim 25, further comprising:
a temperature control module coupled to the two or more charging paths, the temperature control module configured to:
determine a temperature associated with the first charging path; and
selectively cause the second charging path to be in the active state or the inactive state based on the temperature.

27. The apparatus of claim 25, wherein:
the at least one output power node includes a first output power node;
the at least one input charging node includes a first input charging node coupled to the first output power node; and
the two or more charging paths are coupled in parallel between the first input charging node and the output charging node.

28. The apparatus of claim 27, wherein the at least one power path includes two or more power paths coupled in parallel between the at least one receiving element and the first output power node.

29. The apparatus of claim 27, wherein:
the first charging path includes a switch-mode power circuit; and
the second charging path includes a charge pump.

30. The apparatus of claim 25, wherein:
the at least one output power node includes a first output power node and a second output power node;
the at least one power path includes:
a first power path coupled between the at least one receiving element and the first output power node; and
a second power path coupled between the at least one receiving element and the second output power node;
the at least one input charging node includes:
a first input charging node coupled to the first output power node; and
a second input charging node coupled to the second output power node;
the two or more charging paths includes a third charging path coupled between the second input charging node and the output charging node;
the first charging path is coupled between the first input charging node and the output charging node; and
the second charging path is coupled between the first input charging node and the output charging node.
